(19) United States
(12) Patent Application Publication
(10) Pub. No.: US 2009/0200168 A1
(43) Pub. Date: Aug. 13, 2009

(54) ELECTRICAL CONTACT ELEMENT FOR MICROFLUIDIC CHIP

(75) Inventor: Stefan Falk-Jordan, Waldbronn (DE)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(73) Assignee: AGILENT TECHNOLOGIES, INC., Santa Clara, CA (US)

(21) Appl. No.: 12/092,426

(22) PCT Filed: Nov. 2, 2005
(86) PCT No.: PCT/EP05/55685

§ 371 Date: Oct. 3, 2008

(51) Int. Cl. B01D 57/02; H01B 1/00; B01D 17/06

(52) U.S. Cl. 204/601; 174/9 F; 204/660

(57) ABSTRACT

A contacting device, comprising a contacting element (104) for providing an electrical contact to fluid (103) insertable into a well (105) of a carrier element (106) to be coupled to a microfluidic chip (107), wherein the contacting element (104) is adapted to be attachable to or to be integrally formed with the carrier element (106).

### BACKGROUND ART

The present invention relates to an electrical contact element for a microfluidic chip.

In microstructure technology applications, fluid may be conveyed through miniaturized channels (which may be filled with gel material). For a capillary electrophoresis device as an example for such a microstructure technology application, it may be necessary to generate an electric field in the fluid channels in order to allow for a transport of components of the fluid through the channels by means of electric forces. Such an electric force or field may conventionally be generated by dipping contact pins of the capillary electrophoresis device into the fluid which may be filled in a well defined by a carrier element coupled to a microfluidic chip, and by applying an electrical voltage to such contact pins.

WO 00/78454 A1, DE 199 28 412 A1, and U.S. Pat. No. 6,814,846 by the same applicant Agilent Technologies disclose a module unit made as a replaceable cartridge, which is integrated in a supply system for a microchip. Supply lines (conduits) of the supply system are fed to outside by means of an appropriate contact electrode array designed as an interchangeable contact plate. Using an internal basic supply system for the entire handling system, the cartridge is connected via plug-in connections which interact with corresponding opposite components envisaged in a second module which activate the corresponding contact connections when the cartridge is plugged into the module.

U.S. Pat. No. 6,835,293 B2 discloses an analysis system comprising a main body with a surface, at least one analysis unit consisting of at least two reservoirs placed in flow connection by at least one passage being provided in the main body. Two electrical conductors are provided in the main body or on the surface, a first respective end region thereof being connected respectively to one of the at least two reservoirs and a respective second end region of the conductors being connected to or constituting a contact point on the surface of the main body.

### DISCLOSURE

It is an object of the invention to improve contacting fluid in a microfluidic chip. The object is solved by the independent claims. Exemplary embodiments are shown by the dependent claims.

According to an exemplary embodiment of the present invention, a contacting device is provided, the contacting device comprising a contacting element (for instance an at least partially electrically or metallically conducting structure) for providing an electrical contact to fluid (which may also be electrically conducting, for instance an electrolyte) insertable into a well (for instance a cavity with an opening in an upper portion) of a carrier element (for instance a so-called caddy made of an electrically insulting material) to be coupled to a microfluidic chip (for example a glass chip with microchannels for a biochemical analysis), wherein the contacting element is adapted to be attachable to (i.e. as a separate element) or to be integrally formed with (i.e. as a part of) the carrier element.

According to another exemplary embodiment, a fluid separation apparatus (for instance a complete/autarkic analysis system or a readily mounted microfluidic chip arrangement adapted for use in combination with such an analysis system) for separating compounds of a fluid is provided, the fluid separation apparatus comprising a microfluidic chip, and a contacting device having the above-mentioned features and including the carrier element, wherein the carrier element is coupled to or is to be coupled to the microfluidic chip.

According to still another exemplary embodiment, a method of providing an electrical contact to fluid insertable in a well of a carrier element to be coupled to a microfluidic chip is provided, wherein the method comprises providing the electrical contact by means of a contacting element which is attached to or which is integrally formed with the carrier element.

According to an exemplary embodiment, an electrical contact (for instance an intermediate contact structure) is provided for electrically connecting a fluid of a microfluidic chip to external contacts of a supply system. By such an electrical adapter, it is possible to supply an electric potential to the fluid in an indirect manner so as to generate an electric field in channels of the microfluidic chip. Such an electric field may be desired for generating a force acting on electrically charged components of the fluid for transporting components of the fluid to be analyzed through the channels of the microfluidic chip.

Thus, such a contacting may be suitable for an electrophoresis device, for instance a capillary electrophoresis device/a gel electrophoresis device. By such an indirect contactation electrically bridging an external fluid separation system with the fluid inserted in a well of the microfluidic chip, a direct straight contact between external contact pins of the fluid separation system on the one hand and the fluid on the other hand may be avoided. Thus, any contamination of the contact pins with aggressive components possibly present in the fluid may be securely prevented. This may allow to produce the contact pins or other contact elements of the fluid separation system by a cheap metal, since this material does not necessarily be (bio-)chemically inert. Thus, an expensive inert metal like platinum may be dispensable when manufacturing the contact elements of the fluid separation system. Cheaper materials like gold, silver, copper or even copper may be used.

Furthermore, the contact pins need not be cleaned after each use, since a direct contact with biological or chemical samples may be avoided. The intermediate contacting element according to an exemplary embodiment may be adapted for single-use, that is to say may be disposable after use. Any contamination of an analyte by impurities remaining on a surface of a contact pin from a previous measurement or experiment may thus be securely avoided. Beyond this, it may be dispensable to form expensive contact elements directly on the microfluidic (glass) chip, since a contact device according to an embodiment may provide electrically conducting coupling structures positioned at the carrier element.

In other words, according to an exemplary embodiment, an electrode of an external biochemical analysis device does not has to be dipped directly into a fluid under investigation, but may provide an electric (high) potential for generating electric fields within the channels of the microfluidic device in an indirect manner by means of an intermediate element in the form of the contacting device which may be positioned between the fluid separation system and the microfluidic chip, thus bridging these two elements.

The contacting element needs not to be attached to the microfluidic chip, and needs not to be attached to the fluid separation device, but may instead be only attached to the carrier element which may be an electrically insulating caddy provided between a glass chip and the control device. Therefore, the contacting element may form part of the carrier element or may be fastened at the carrier element.

According to an exemplary embodiment, the contact element (for instance a metallization) may be guided from the inside of the well to the outside of the microfluidic chip arrangement to be brought in contact with the fluid separation device.

Consequently, it may be no longer necessary to directly contact fluid in microfluidic chips by means of dipping pins of a cartridge into the fluid. It may further be dispensable that, together with a channel structure of a glass chip, contact areas are directly formed on the glass surface extending into the wells (for instance by depositing gold material on the glass). In contrast to such an approach, embodiments of the invention provide contacts in touch or to be coupled with a caddy. This approach may be cheap, since it may not be necessary to treat the glass surface by means of a gold deposition method. Simultaneously, a direct contact between a control apparatus and a liquid can be avoided by interposing or interfacing a caddy-bound contact.

According to an exemplary embodiment, an indirect contacting integrated with the carrier element or touching the carrier element is provided. Such an indirect contacting structure may then be connected to a voltage supply unit, for instance for producing a high voltage to generate a sufficiently strong electric field in the channels of the electrophoresis device. The contacts may be fixed at the carrier element by means of simple, cheap and efficient clips or other means for attaching the contacting element at the carrier element. Thus, the carrier element or caddy may be equipped with the contacting element.

Thus, according to an exemplary embodiment, pin contacts may be electrically connected directly to caddy well contacts, which in turn provides a direct electrical contact down into fluid located into the well.

According to an exemplary embodiment, a packaged chip may be provided with integrated caddy-bound contacts. For instance, a plastic caddy may be coupled to one or more glass chips, wherein wells provided in the plastic caddy serve to receive fluid which may then be introduced into (horizontal) channels and/or (vertical) through holes formed in the chip. On the plastic caddy, particularly in the wells of the plastic caddy, the contacting element may be located which may automatically contact fluid filled in the well and which may also be contacted from an external position by means of pins or other contacting elements of a fluid separation device. The wells and/or the channels of the microfluidic glass chip may filled with an electrolyte so that an electric field may be generated by applying an electrical direct voltage to the contacting elements according to an exemplary embodiment.

For instance, the contacting element may be made of a combination of electrically insulating PEEK (PolyEtherEtherKetone) with an addition of electrically conductive fibers, for instance carbon fibres (with a contribution of for instance 30%), which may make the resulting material electrically conductive. PEEK is a synthetic material suitable for injection moulding which may ensure a cost-efficient production. As an alternative to the addition of carbon fibres to obtain a material having a sufficiently high electrical conductivity, it is also possible to mix the PEEK material (or other plastics material) with a metal powder. Such a mixture may also be suitable for injection moulding.

An electrically conductive part of a contacting element may also be manufactured by depositing (for instance by vacuum deposition) electrically conductive material onto a surface (portion) of an electrically insulating substrate.

The electrically conducting intermediate element may be shaped as some kind of mat which may be put onto a caddy for obtaining a cost efficient arrangement. Such a mat can be substituted after each experimental analysis performed with a fluid separation device so that any contamination may be efficiently avoided with low effort.

For instance, the caddy may be positioned onto the microfluidic chip, and such a contacting mat may be positioned on the top of the caddy. The mat may then be contacted (from above) by means of contact pins (for instance spring biased contacts like pogopins).

It is also possible to manufacture such an inlay or mat by injection moulding, for instance by depositing conductive material directly onto the caddy (more precisely: onto a surface inside the wells of the caddy).

Thus, according to an exemplary embodiment, an indirect contactation may be provided which is connected to the caddy (that is to say to the carrier substrate of the microfluidic chips).

Within the mat, holes may be provided to allow an access to the wells, for instance for filling the fluid in the wells after having mounted the contact device. In case that one or more holes are provided in the mat, it is possible to supply the sample also after having assembled the intermediate contactation element.

Alternatively, the mat may be free of any holes so that the mat may mechanically decouple the fluid completely from the exterior of the microfluidic chip arrangement. Simultaneously, the electrically conductive mat provides an electrical coupling between the fluid and the exterior. This may securely avoid any contamination and may further ensure a reliable contactation.

It may be advantageous to select the dimensions, the distances and the insulation properties of the contacting element so as to avoid or suppress electrical crosstalk between electric signals running on different conductive parts of the system.

Exemplary fields of application are biochemical analysis devices, particularly capillary electrophoresis devices and gel electrophoresis devices. Thus, exemplary technical application fields of the system are products for electrophoresis devices (for performing an electrical separation of components of an analyte). Furthermore, the system may be used in a lab-on-chip. However, the disclosed technology may also be applied in any other technical field in which fluids have to be electrically contacted. For instance in a battery, a contacting element between an electrolyte and an external contact might be advantageous in order to avoid material deposition or corrosion of electrodes. The system according to an embodiment may also be applied to a pH meter, that is to say to a device for measuring a pH value.

Particularly, embodiments of the system may be advantageously applied in all fields of microstructure technology applications including miniaturized channels in which a fluid shall be inserted and shall be made subject of an electric field treatment.

In the following, further exemplary embodiments will be described.

Next, exemplary embodiments of the contacting device will be explained. However, these embodiments also apply for the fluid separation apparatus and for the method of providing an electrical contact to fluid.

The contacting element may be shaped corresponding to a shape of the well so as to be positionable at least partially within the well of the carrier element. For instance, when the well has a circular shape, the contacting element may also have a circular shape with slightly smaller dimensions so that the contacting element may be mounted in the well with a closed linkage.

The contacting element may have a first surface to be attached to the carrier element and may have a second surface to contact the fluid. Such a two-sided contacting element may provide two functions simultaneously, a proper fastening at the carrier element and an ohmic connection to the fluid to which an electrical field shall be applied.

The contacting element may be a continuous structure or layer to be positioned inside of the well of the carrier element so as to seal the interior of the well with respect to the exterior of the well. By taking this measure, the contacting element may be provided as a non-stop continuous layer without any holes or recesses so that a complete mechanical decoupling between the interior and the exterior of the well may be obtained. Such a sealing may protect the fluid filled in the well and may further avoid an unwanted contamination of an exterior part of the apparatus with the fluid (which might be chemically or biologically aggressive, for instance an RNase). Alternatively, the contacting element may be a layer having holes, so that the fluid may be inserted through the holes even after having mounted the contacting element.

The contacting element may be shaped to be pressed or to be clicked into the well of the carrier element. However, press or click connections are only exemplary embodiments of fastening mechanisms for fastening the contacting element in the carrier element. It is also possible to fasten the contacting element in the carrier element by means of magnetic forces, by means of a hook and loop fastener, with a snap-in connection, or the like.

The contacting element may comprise a ring-like portion adapted to be inserted into or to surround the well of the carrier element and may comprise a stud-like portion connected to the ring-like portion and adapted to extend into the well of the carrier element. For instance, the contacting element may be shaped like an O-ring with a linear projection extending from the O-ring. Such a configuration may be obtained by blanking or punching or perforating a planar metallic foil. Then, the stud-like projection may be turned down so as to extend into the well in which the fluid may be filled in. Then, the ring-like portion may serve as a contact to the fluid separation device, and the stud-like portion may dip into the fluid to convey the electric potential. The term “ring-like” (or annular) may particularly include a circular ring or any other ring geometry (that is any structure having a hole surrounded by material). The exterior and/or interior boundary of the material may be round, oval, polygonal (particularly triangular, rectangular, quadratic), etc.

The contacting device may be adapted for single-use. Thus, the contacting device may be manufactured cheap and with low effort and may be provided to be replaceable after each measurement to avoid any contamination.

However, it is also possible that the contacting device is adapted for multiple-use. For example, after use, one or more of the contacting devices may be sterilized, for instance by means of an autoclave. After that, the cleaned contacting devices may be reused.

Particularly, the contacting element may be detachable from the carrier element and/or from the microfluidic chip. Detaching or removing the contacting element from the carrier element or the microfluidic chip may improve or refine the single-use function of the contacting device, and may provide a flexible modular system.

The contacting element of the contacting device may be an intermediate contacting element for providing an indirect electrical contact between at least one electrically conductive contact pin and the fluid insertable in the well of the carrier element attachable to the microfluidic chip. Thus, the contacting element may serve as an adapter or a bridge for electrically connecting the pins to the fluid.

The contacting element may be adapted for providing contact between a fluid separation apparatus and the fluid insertable into the well of the carrier element to be coupled to the microfluidic chip. Thus, the contacting device according to an exemplary embodiment may interact with a cartridge (having a pin array) of a fluid separation device in a similar manner as disclosed in WO 00/78454 A1. However, according to an embodiment, such a cartridge may be produced with reduced effort, particularly with cheaper contact pins, since there is no direct contact of the pins with fluid to be analyzed.

The contacting device may be adapted as an inlay device, comprising an electrically insulating substrate having at least one through hole, and comprising the contacting element inserted into the at least one through hole for providing an electrical contact to the fluid insertable in the at least one well of the carrier element to be coupled to the microfluidic chip. Such an inlay device (for instance shaped like a mat) may be a separable or detachable component of the contacting device which, for instance, may be substituted after each measurement. Such an inlay device with conductive and non-conductive portions may simply be sandwiched between the carrier element and the fluid separation device to be contacted.

The electrically insulating substrate may be essentially planar. Thus, the inlay device may be designed in a layer-shaped manner or in a mat-like manner.

The inlay device may comprise a plurality of the contacting elements inserted into a plurality of the through holes formed in the electrically insulating substrate for providing an electrical contact to the fluid insertable in a plurality of the wells of the carrier element to be coupled to the microfluidic chip. Thus, the inlay device may be designed as an array with, for instance, matrix-like arranged contacting elements. Such an array may be designed to geometrically correspond to a cartridge, for instance of the type as disclosed in WO 00/78454 A1.

The inlay device may be detachable from the carrier element. Thus, the inlay device may be disposable after use, and may thus be a single-use device.

The electrically insulating substrate may comprise PolyEtherEtherKetone (PEEK) for establishing electrical insulation. Embedded in such an electrically insulating matrix, the contacting element or elements may be embedded, for instance made of a mixture of PolyEtherEtherKetone (PEEK) and carbon fibers or metallic particles, for establishing electrical contact. Thus, an integrally formed inlay device may be obtained which is cheap to manufacture, which has good material properties in use and which is capable of being formed by injection molding. The carbon fibers or the metallic particles embedded in the PEEK substrate may provide for the electrical (metal-like) conductivity. The electrically insulating PEEK material between the contacting elements may support an electrical decoupling between the different electrical contacting elements which may thus be operated or electrically controlled separately from one another. The carrier element may be a component of the contacting device. Thus, a caddy having the contacting elements provided therein may be provided. The contacting elements may be provided removably from the carrier element or may be provided as separate elements. Alternatively, it is possible to integrally form the carrier element with the contacting element(s) so as to have one piece or member which may be mounted or assembled in an easy manner.

In the following, exemplary embodiments of the fluid separation apparatus will be described. However, these embodiments also apply for the contacting element and for the method of providing an electrical contact to fluid.

In the fluid separation apparatus, the microfluidic chip may comprise at least one channel for channeling the fluid and/or at least one through hole for conveying the fluid from the well into the at least one channel. Such a microfluidic chip may thus comprise two (glass) substrates which may be connected by bonding. One of the substrates may contain the channels provided in a surface region of this substrate, and the other substrate may comprise through holes which may be provided essentially vertical with respect to the substrate surface. When being bonded, a proper alignment of the through holes with respect to the channels should be guaranteed. Then, fluid may be inserted to the through holes (for instance via the well) and may then be supplied to the channels in fluid communication with the through holes.

The microfluidic chip may be made of at least one of the group consisting of glass, a semiconductor material, a plastics material, a ceramics material and a metallic material. However, embodiments of the invention are not restricted to these materials and may also be used with other materials. When using a semiconductor substrate, this can be made from silicon, germanium, or a group III-group V semiconductor, like gallium arsenide.

The fluid separation apparatus may comprise a separation control unit adapted for controlling separation of compounds of the fluid. Such a control unit may control the voltages applied to the fluid, the supply of fluids, a separation scheme or sequence, or the like.

The fluid separation device may be a gel electrophoresis device or a liquid chromatography device, for instance an HPLC (High Performance Liquid Chromatography).

The microfluidic chip of the fluid separation apparatus may have microchannels into which a fluid and/or a gel may be introduced. “Microfluidics” may particularly be denoted as the science of designing, manufacturing, and forming devices and processes with volumes of liquid in the order of microlitres, nanolitres or picolitres. Such devices themselves may particularly have dimensions ranging from centimetres, millimetres down to micrometres.

The fluid separation apparatus may be adapted to analyze at least one of the group consisting of a physical, a chemical and a biological parameter of at least one component of the fluid. Examples for physical parameters are temperature, pressure, volume, or the like. Examples for chemical parameters are a concentration of a component, a pH value of a liquid, or the like. Examples for biological parameters are the presence or absence of proteins or genes in a solution, the biological activity of a sample, or the like.

The fluid separation apparatus may comprise at least one of a sensor device, a device for chemical, biological and/or pharmaceutical analysis, a capillary electrophoresis device, a liquid chromatography device, a gas chromatography device, an electronic measurement device, and a mass spectroscopy device. Exemplary application fields are gas chromatography, mass spectroscopy, UV spectroscopy, optical spectroscopy, IR spectroscopy, liquid chromatography, and capillary electrophoresis (bio-)analysis. The fluid separation apparatus may be integrated in an analysis device for chemical, biological and/or pharmaceutical analysis. When the fluid separation apparatus is a device for chemical, biological and/or pharmaceutical analysis, functions like (protein) purification, electrophoresis investigation of solutions, fluid separation, or chromatography investigations may be performed with such an analysis device.

The fluid separation apparatus may comprise at least one electrically conducting contact to be electrically connected to the contacting element for providing the electrical contact to the fluid insertable into the well of the carrier element to be coupled to the microfluidic chip. Thus, also the fluid separation device may have pins or other electric coupling structures which are adapted to contact the intermediate contactation, that is to say the contacting element of the contacting device. Such electrically conducting contacts may be pins of the type of the cartridge as disclosed in WO 00/78454 A1.

The at least one electrically conducting contact may be at least one spring-loaded electrical contact. Such a configuration of an electrically conducting contact which may also be denoted as a pogopin, may generate a force biasing the electrically conducting contact against the contacting element to provide a reliable and stable electrical connection which may be securely prevented from an undesired interruption.

The at least one electrically conducting contact may comprise a material of the group consisting of platinum, gold, and silver. Platinum has the advantage that it is chemically inert and thus is securely prevented from changing properties with time. However, since the electrically conducting contact may be prevented from directly contacting the fluid, it is also possible to use less expensive materials like gold, silver, or carbon.

The at least one electrically conducting contact may be a resilient element, so that a biasing force may be generated to improve the contact.

### BRIEF DESCRIPTION OF DRAWINGS

Objects and many of the attendant advantages of embodiments of the present invention will be readily appreciated and become better understood by reference to the following more detailed description of embodiments in connection with the accompanied drawings. Features that are substantially or functionally equal or similar will be referred to by the same reference signs.

FIG. 1 to FIG. 3 show cross-sectional views of fluid separation apparatuses according to exemplary embodiments of the invention.

FIG. 4 and FIG. 5 show perspective views of a contacting device according to an exemplary embodiment.

FIG. 6 and FIG. 7 show perspective views of a contacting device according to an exemplary embodiment.

The illustration in the drawing is schematically.

In the following, referring to FIG. 1, a fluid separation apparatus 100 according to an exemplary embodiment will be described.

The fluid separation apparatus 100 comprises a cartridge 101 similar to the type as disclosed in WO 00/78454 A1. Such a cartridge 101 may comprise a plurality of contact pins 102. However, in FIG. 1, only a single contact pin 102 is shown for the sake of simplicity.

Via the cartridge 101, an electrical potential may be applied to the contact pin 102 which is to be brought in contact with an electrolyte 103 which shall be investigated by means of a capillary electrophoresis experiment.

A contacting device is provided comprising an electrically conductive contacting element 104 for providing an electrical contact to the fluid/analyte 103 inserted in a well 105 of a carrier element 106 (a plastics caddy) coupled to a microfluidic chip 107. The contacting element 104 is shaped corresponding to a shape of the well 105 so as to be positionable partially within the well 105 of the carrier element 106. The contacting element 104 has a first surface 108 attached to the carrier element 106 and has a second surface 109 contacting the fluid 103.

The contacting element 104 is shaped to be pressed in the well 105 of the carrier element 106. The carrier element 106 is essentially planar and has vertical parts defining the well 105 with a tubular shape and a circular opening (not visible in FIG. 1). Since the contacting element 104 is pressed into the carrier element 106, the contacting element 104 is detachable from the carrier element 106. Any other shapes of the opening are possible. For instance, the opening may be round, oval, polygonal (particularly triangular, rectangular, quadratic).

Furthermore, the carrier element 106 is coupled to the microfluidic chip 107, that is to say is mounted or assembled to the microfluidic chip 107.

The microfluidic chip 107 comprises a first glass substrate 110 and comprises a second glass substrate 111 bonded to the first glass substrate 110. In the first glass substrate 110, a plurality of channels 112 are provided, and in the second substrate 111, a plurality of through holes 113 are provided. The first substrate 110 is aligned with respect to the second substrate 111 in such a manner that the position of the channel 112 corresponds to the position of the through hole 113 so that fluid 103 inserted in the through hole 113 may also be brought in the channel 112.

The contacting element 104 is provided as a ring-like element and acts as an intermediate contacting element for providing an indirect electrical contact between the electrically conductive contact pin 102 on the one hand and the fluid 103 inserted in the well 105 of the carrier element 106 attached to the microfluidic chip 107 on the other hand. Thus, the contacting element provides a proper electrical contact between the fluid separation device 101 and the fluid 103 inserted in the well 105 of the carrier element 106 to be coupled to the microfluidic chip 107.

When an electrical potential (for instance several kV) is applied to the pin 102, the voltage is applied, via the contacting element 104, to the electrically conductive fluid 103 so as to generate an electric field also in the channel 112 for transporting electrically charged components of the fluid 103 through the channels 112.

The fluid separation apparatus 100 is adapted for separating components of the fluid 103 by capillary electrophoresis. The channels 112 are adapted for channeling the fluid 103, and the through holes 113 are adapted for conveying the fluid 103 from the well 105 into the channel 112. A control unit (not shown) in the fluid separation apparatus 101 controls the separation of components of the fluids, for instance defines the voltages applied to the fluid 103, and the sequence of experimental steps carried out.

The fluid 103 may be a biological sample, and the task of the configuration of FIG. 1 may be to separate different components (for instance proteins, genes, etc.) of the liquid 103. Furthermore, a gel may be filled in the channels 112.

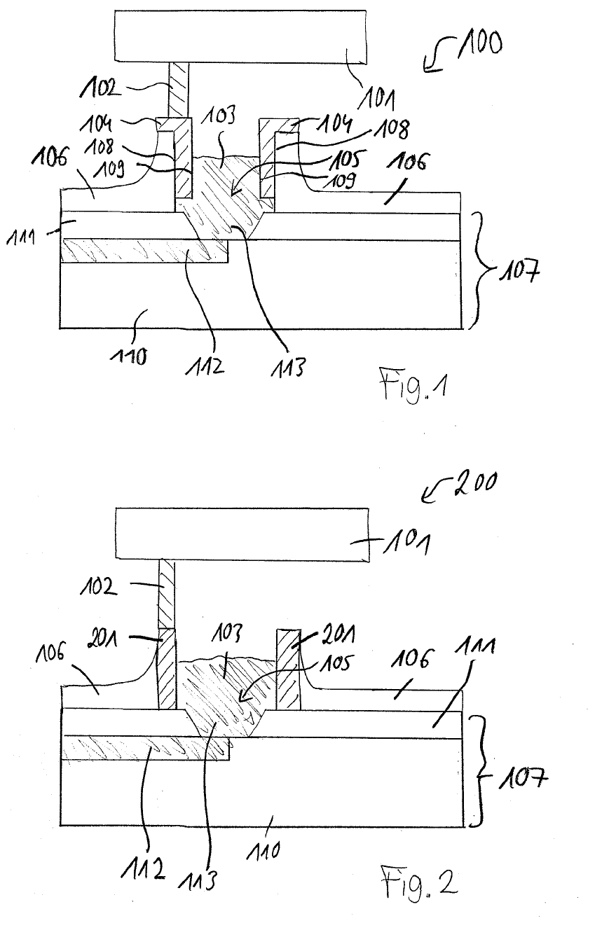

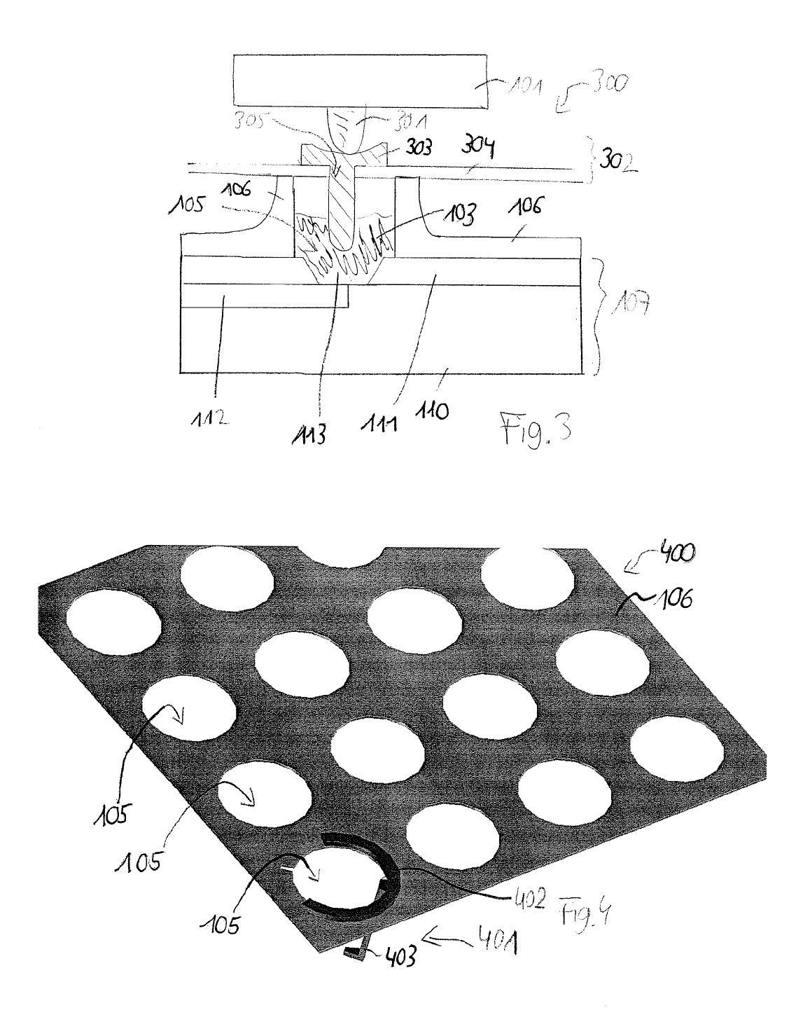

In the following, referring to FIG. 2, a fluid separation apparatus 200 according to another exemplary embodiment will be described.

A main difference between the fluid separation apparatus 200 and the fluid separation apparatus 100 is that, in FIG. 2, a contacting element 201 is provided which is integrally formed with the carrier element 106. In other words, according to the embodiment of FIG. 2, the contacting element 201 may not be separated from the carrier element 106 and forms an integral part of the carrier element 106. For instance, the contacting element 201 may be a metallic material deposited at an inner wall surface of the portion of the carrier element 106 defining the well 105.

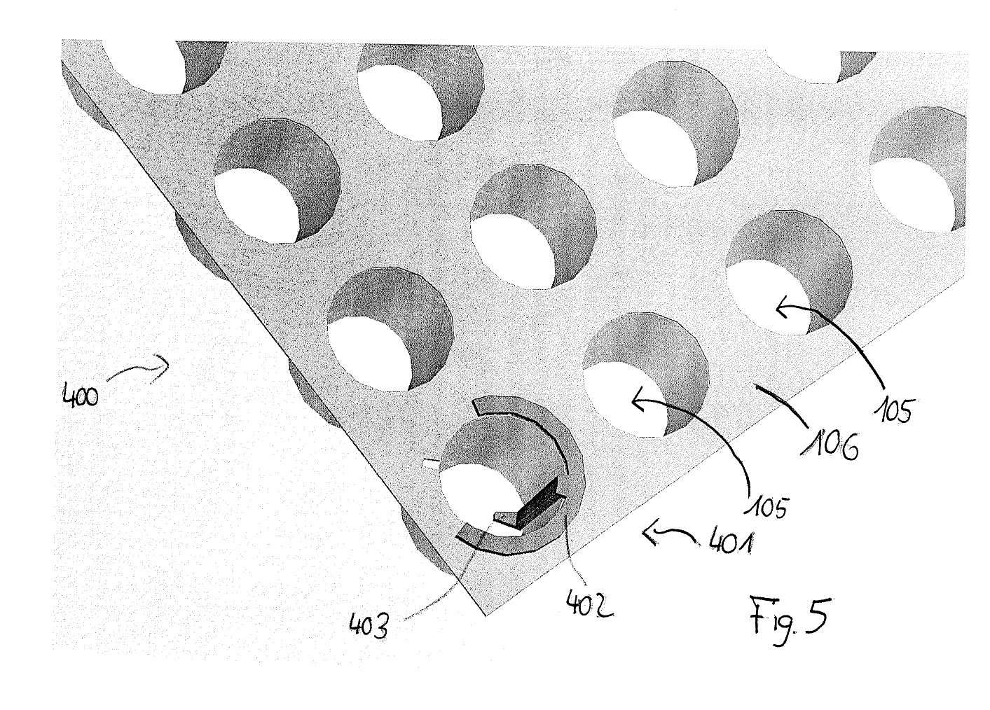

In the following, referring to FIG. 3, a fluid separation system 300 according to another exemplary embodiment will be described.

In the following, mainly the differences between the fluid separation apparatus 300 and the fluid separation apparatus 100 will be discussed.

In contrast to the contacting pin 102, a pogopin 301 is provided in the fluid separation apparatus 300. The pogopin 301 is a spring-loaded electrical contact providing a bias force for biasing the pogopin 301 against a contacting element 303 which will be described in more detail below. The pogopin 301 is made of a metallically conductive material. Furthermore, the spring of the pogopin 301 gives the pogopin 301 the property of a resilient element. The pogopin 301 acts as an electrically conducting contact to be electrically connected to the contacting element 301 for providing a firm electrical connection to the fluid 103 inserted in the well 105 of the carrier element 106 and coupled to the microfluidic chip 107.

In the embodiment of FIG. 3, the contacting element 303 is formed as a part of an inlay element 302. The inlay element 302 is a continuous mushroom-shaped structure positioned inside of the well 105 of the carrier element 106 so as to seal the interior of the well 105 with respect to the exterior of the well 105 like a plug. The inlay device 302 comprises an electrically insulating substrate 304 comprising a through hole 305. The contacting element 303 is inserted in the through hole 305 for providing an electrical contact to the fluid 103 inserted in the well 105 of the carrier element 106 to be coupled to the microfluidic chip 107. The electrically insulating substrate 304 is essentially planar.

The inlay device 302 is detachable from the carrier element 106 and may be substituted after each experiment. Thus, the inlay device 303 may be adapted for single-use. The electrically insulating substrate 304 is made of PolyEtherEtherKetone (PEEK) for establishing electrical isolation. The contacting element 303 is a mixture of PolyEtherEtherKetone (PEEK) and 30% carbon fibers for establishing electrical contact.

FIG. 4 illustrates a contacting device 400 according to an exemplary embodiment.

The contacting device 400 comprises a contacting element 401 for providing an electrical contact to fluid insertable in a well 105 of a carrier element 106 to be coupled to a microfluidic chip. The contacting element 401 is attached to the carrier element 106. The carrier element 106 is designed as an electrically insulating substrate with a plurality of through holes by which the wells 105 are defined. The contacting element 401 is pressed in any of the through holes of the carrier element 106.

The contacting element 401 comprises a ring-like portion 402 adapted to surround the well 105, and comprises a stud-like portion 403 connected to the ring-like portion 402 and adapted to extend into the well 105 of the carrier element 106. Thus, the ring-like element 402 allows to fasten the contacting element 401 in the through holes of the carrier element 106, and the stud-like portion 403 allows to contact fluid contained in the wells 105.

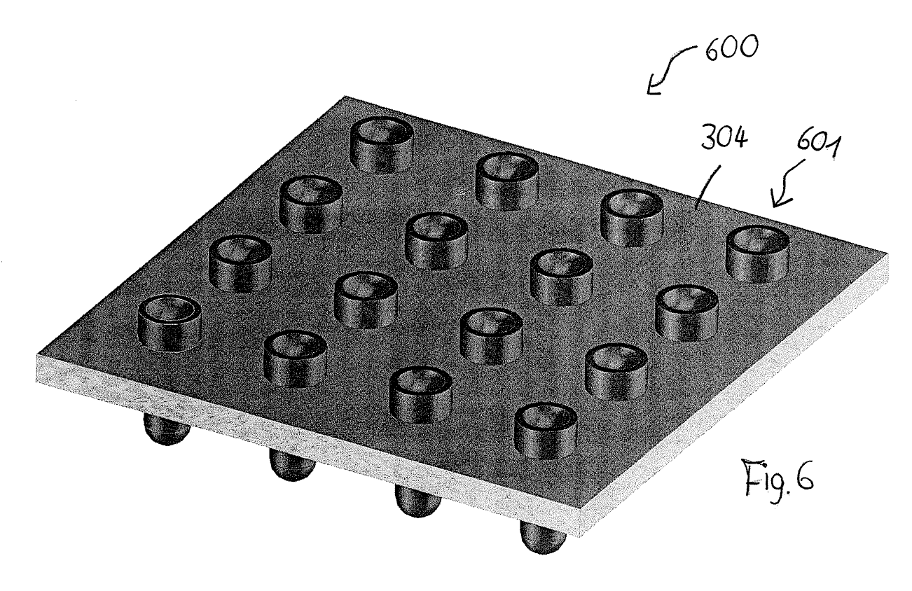

FIG. 5 shows the contacting device 400 in more detail.

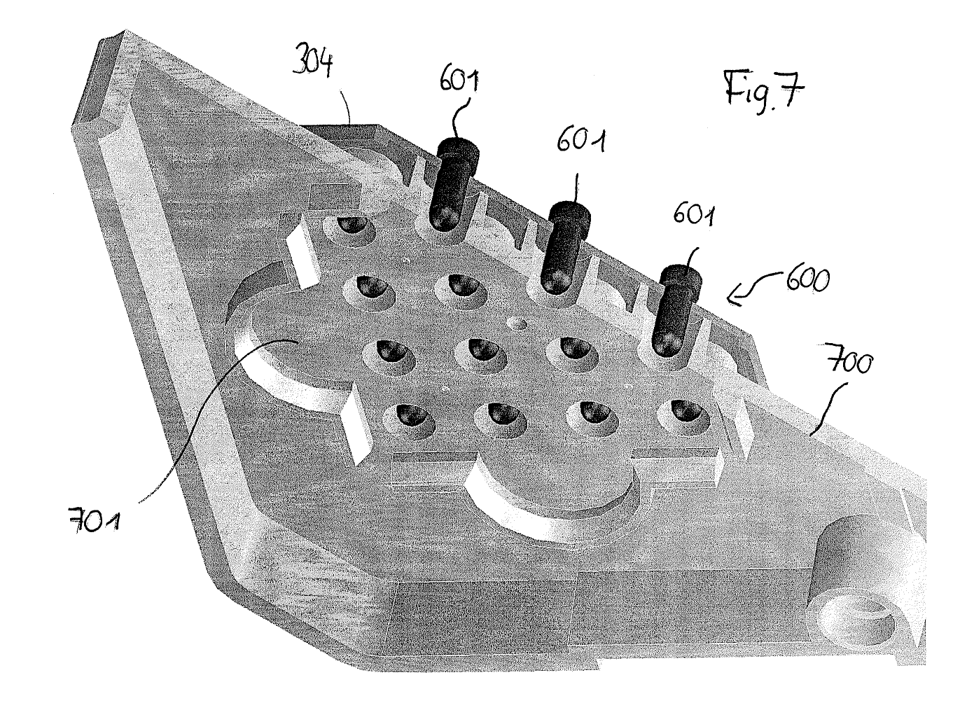

In the following, referring to FIG. 6, a contacting device 600 according to an exemplary embodiment will be described.

The contacting element 600 comprises a contacting element 601 for providing an electrical contact to fluid insertable into a well of a carrier element 304 to be coupled to a microfluidic chip. The contacting element 601 is connected by press-fitting with the carrier element 304.

The contacting element 601 is a continuous plug-like structure to be positioned inside of the well of the carrier element 304 so as to seal the interior of the well with respect to the exterior of the well.

Furthermore, the contacting device 600 is an inlay device comprising the electrically insulating substrate 304 made of PEEK material and comprising the contacting element 601 inserted in the through holes of the electrically insulating substrate for providing an electrical contact to the fluid insertable in the wells of the carrier element 304 to be coupled to the microfluidic chip. The electrically insulating substrate 304 is planar.

FIG. 7 shows a configuration in which the inlay element shown in FIG. 6 is inserted in a carrier element or caddy 700.

As can be seen in FIG. 7, a reception 701 is defined and shaped for receiving a microfluidic chip (like the microfluidic chip 107 shown in FIG. 1) so as to electrically couple fluid provided in the through hole 113 of such a microfluidic chip 107 via the electrically conductive contacting elements 601 to an exterior apparatus.

It should be noted that the term “comprising” does not exclude other elements or steps and the “a” or “an” does not exclude a plurality. Also elements described in association with different embodiments may be combined. It should also be noted that reference signs in the claims shall not be construed as limiting the scope of the claims.

1. An electrical contacting device, comprising
a contacting element for providing an electrical contact to fluid in a well of a carrier element coupled to a microfluidic chip,
wherein the contacting element is adapted to be attached to or to be integrally formed with the carrier element,
the contacting element is shaped to correspond to a shape of the well so as to be positionable at least partially within the well of the carrier element, and
the contacting element has a first surface to be attached to the carrier element and has a second surface to contact the fluid.

2. The contacting device of claim 1, comprising at least one of:
the contacting element is a continuous structure or layer to be positioned inside of the well of the carrier elements so as to seal the interior of the well with respect to the exterior of the well;
the contacting element is shaped to be pressed or to be clicked into the well of the carrier element;
the contacting element comprises a ring-like portion adapted to be inserted into or to surround the well of the carrier element and comprises a stud-like portion connected to the ring-like portion and adapted to extend into the well of the carrier element;
the contacting device is adapted for single-use;
the contacting element is detachable from the carrier elements and/or from the microfluidic chip;
the contacting element is an intermediate contacting element for providing an indirect electrical contact between at least one electrically conductive contact pin and the fluid insertable in the well of the carrier element attachable to the microfluidic chip;
the contacting element is adapted for providing contact between a fluid separation apparatus and the fluid insertable into the well of the carrier element to be coupled to the microfluidic chip.

3. The contacting device of claim 1, being adapted as an inlay device comprising
an electrically insulating substrate comprising at least one through hole; and
the contacting elements inserted into the at least one through hole for providing an electrical contact to the fluid insertable in the at least one well of the carrier element to be coupled to the microfluidic chip.

4. The contacting device of claim 3, comprising at least one of:
the electrically insulating substrate is essentially planar;
the inlay devices comprises a plurality of the contacting elements inserted into a plurality of the through holes formed in the electrically insulating substrate for providing an electrical contact to the fluid insertable in a plurality of the wells of the carrier element to be coupled to the microfluidic chip;
the inlay device is detachable from the carrier element;
the electrically insulating substrate comprises PolyEtherEtherKetone for establishing electrical isolation;
the contacting element comprises a mixture of PolyEtherEtherKetone and carbon fibers for establishing electrical contact.

5. The contacting device of claim 1,
wherein the contacting device comprises the carrier element.

6. A fluid separation apparatus for separating compounds of a fluids, the fluid separation apparatus comprising
a microfluidic chip;
a carrier element coupled to the microfluidic chip, and
an electrical contacting device of claim 1, adapted to be attached to or to be integrally formed with the carrier element for providing an electrical contact to a fluid in a well of the carrier element.

7. The fluid separation apparatus of claim 6, comprising at least one of:
the microfluidic chip comprises at least one channel for channeling the fluid and/or at least one through hole for conveying the fluid from the well into the at least one channel;
the microfluidic chip is made of at least one of the group consisting of glass, a semiconductor material, a plastics material, a ceramics material and a metallic material;
the fluid separation apparatus comprises a separation control unit adapted for controlling separation of compounds of the fluid;
the fluid separation apparatus is adapted to analyze at least one of the group consisting of a physical, a chemical and a biological parameter of at least one compound of the fluid;
the fluid separation apparatus comprises at least one of a sensor device, a device for chemical, biological and/or pharmaceutical analysis, a capillary electrophoresis device, a liquid chromatography device, a gas chromatography device, an electronic measurement device, and a mass spectroscopy device.

8. The fluid separation apparatus of claim 6,
comprising at least one electrically conducting contact to be electrically connected to the contacting element for providing the electrical contact to the fluid insertable into the well of the carrier element to be coupled to the microfluidic chip.

9. The fluid separation apparatus of claim 8, comprising at least one of:
the at least one electrically conducting contact is at least one spring-loaded electrical contact;
the at least one electrically conducting contact comprises a material of the group consisting of platinum, gold, and silver;
the at least one electrically conducting contact is a resilient element.

10. A method of providing an electrical contact to fluid in a well of a carrier element coupled to a microfluidic chip, wherein the method comprises
using a contacting element providing the electrical contact, wherein the contacting element is attached to or which is integrally formed with the carrier element, the contacting element is shaped to correspond to a shape of the well, so as to be positionable at least partially within the well of the carrier element, and the contacting element has a first surface to be attached to the carrier element and has a second surface to contact the fluid.
